(19) United States
(12) Patent Application Publication
(10) Pub. No.: US 2024/0141525 A1
(43) Pub. Date: May 2, 2024

(54) ELECTROSYNTHESIS SYSTEM

(71) Applicant: HONDA MOTOR CO., LTD., TOKYO (JP)

(72) Inventors: Masahiro MOHRI, WAKO-SHI (JP); Kazuki YANAGISAWA, WAKO-SHI (JP); Misato MAKI, WAKO-SHI (JP); Hideaki YONEDA, WAKO-SHI (JP); Jumpei YOSHIDA, WAKO-SHI (JP)

(21) Appl. No.: 18/384,064

(22) Filed: Oct. 26, 2023

(30) Foreign Application Priority Data
Nov. 1, 2022 (JP) 2022-175534

(51) Int. Cl. C25B 15/08; B01D 53/26; B01J 19/00; C25B 1/042; C25B 1/23; C25B 9/67; C25B 15/029

(52) U.S. Cl. CPC C25B 15/081; B01D 53/265; B01J 19/0006; C25B 1/042; C25B 1/23; C25B 9/67; C25B 15/029; B01D 2257/80; B01J 2208/00628

(57) ABSTRACT

An electrosynthesis system is equipped with an electrolysis device that carries out electrolysis on carbon dioxide gas and water vapor, a synthesizing device that synthesizes a hydrocarbon gas from hydrogen gas and carbon monoxide gas that are generated by the electrolysis, and a control device. The control device adjusts a flow rate of the water vapor supplied to the electrolysis device, in a manner so that a first concentration ratio, which is a concentration ratio between the hydrogen gas and the carbon monoxide gas in a mixed gas discharged from the electrolysis device and containing the hydrogen gas and the carbon monoxide gas, becomes a predetermined target concentration ratio.

### CROSS-REFERENCE TO RELATED APPLICATIONS

This application is based upon and claims the benefit of priority from Japanese Patent Application No. 2022-175534 filed on Nov. 1, 2022, the contents of which are incorporated herein by reference.

### BACKGROUND OF THE INVENTION

### Field of the Invention

The present invention relates to an electrosynthesis system.

### Description of the Related Art

In recent years, efforts have been made to substantially reduce waste generation through prevention, reduction, recycling and reuse. Toward the realization thereof, research and development are being carried out in relation to an electrosynthesis system. An electrosynthesis system is a system in which carbon dioxide gas and water vapor are subjected to electrolysis, and a hydrocarbon gas such as methane or the like is synthesized based on hydrogen gas and carbon monoxide gas obtained by the electrolysis.

In JP 2022-022978 A, a method for the co-production of methanol and methane is disclosed. Such a method includes an electrolysis process and a methane synthesis process. In the electrolysis process, water vapor and carbon dioxide gas are reduced in a solid oxide electrolytic cell, whereby hydrogen gas and carbon monoxide gas are generated. In the methane synthesis process, using a methanation catalyst, methane is synthesized from the hydrogen gas and the carbon monoxide gas that were generated in the electrolysis process.

### SUMMARY OF THE INVENTION

In the methane synthesis process of JP 2022-022978 A, a chemical reaction formula of the synthesis reaction is “3H₂+CO->CH₄+H₂O”. Therefore, in order to increase the efficiency of the synthesis of methane in the methane synthesis process of JP 2022-022978 A, it is desirable for the ratio of the hydrogen gas to the carbon monoxide gas obtained in the electrolysis process of JP 2022-022978 A to be “3:1”.

However, in general, the concentration ratio between the hydrogen gas and the carbon monoxide gas obtained in an electrolysis process tends to fluctuate due to various factors, such as deterioration of the solid oxide electrolytic cell or the like. In the case that the concentration ratio between the hydrogen gas and the carbon monoxide gas obtained in the electrolysis process fluctuates, a problem arises in that the efficiency of the synthesis of hydrocarbons such as methane or the like that are synthesized from the hydrogen gas and the carbon monoxide gas is reduced.

The present invention has the object of solving the aforementioned problem.

An aspect of the present invention is characterized by an electrosynthesis system comprising an electrolysis device configured to perform electrolysis on carbon dioxide gas and water vapor, and a synthesizing device configured to synthesize hydrocarbon gas from hydrogen gas and carbon monoxide gas that are generated by the electrolysis, the electrosynthesis system further comprising a first analyzer configured to measure a first concentration ratio, which is a concentration ratio between the hydrogen gas and the carbon monoxide gas in a mixed gas discharged from the electrolysis device and containing the hydrogen gas and the carbon monoxide gas, and a control device configured to adjust a flow rate of the water vapor supplied to the electrolysis device, in a manner so that the first concentration ratio becomes a predetermined target concentration ratio.

According to the above-described aspect, the respective gases can be supplied to the synthesizing device in a state in which the distribution of the hydrogen gas and the carbon monoxide gas is appropriate. Accordingly, hydrocarbon gas can be stably synthesized without waste. As a result, it is possible to suppress a decrease in the efficiency of the synthesis of the hydrocarbon gas. This in turn contributes to a significant reduction in the generation of waste.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing the configuration of an electrosynthesis system according to an embodiment;

FIG. 2 is a flowchart showing the procedure of a system control process;

FIG. 3 is a flowchart showing the procedure of a preprocessing routine;

FIG. 4 is a flowchart showing the procedure of a normal temperature startup routine;

FIG. 5 is a flowchart showing the procedure of a low temperature startup routine;

FIG. 6 is a flowchart showing the procedure of a normal temperature regular operation routine; and

FIG. 7 is a flowchart showing the procedure of a low temperature regular operation routine.

### DETAILED DESCRIPTION OF THE INVENTION

### Embodiment

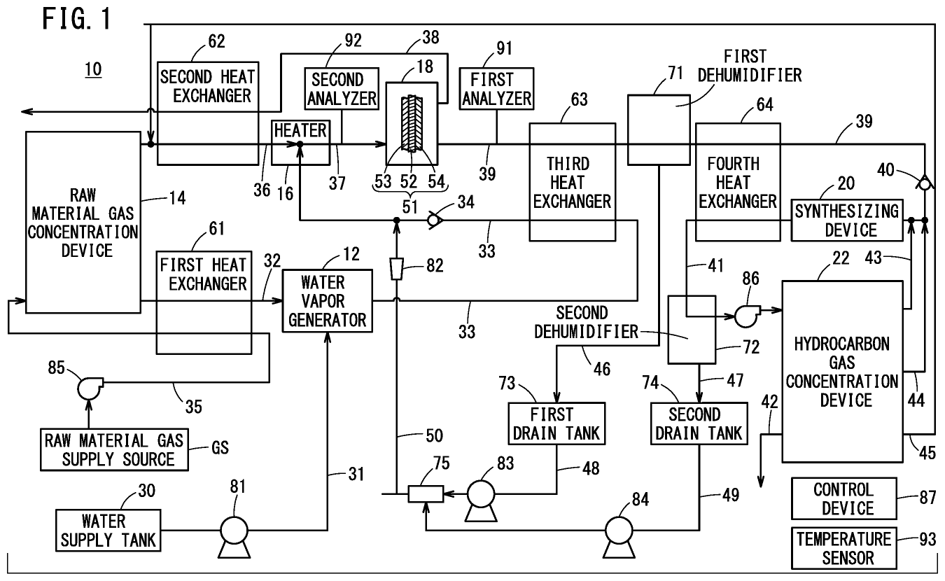

FIG. 1 is a schematic diagram showing the configuration of an electrosynthesis system 10 according to an embodiment. The electrosynthesis system 10 is equipped with a water vapor generator 12, a raw material gas concentration device 14, a heater 16, an electrolysis device 18, a synthesizing device 20, and a hydrocarbon gas concentration device 22.

The water vapor generator 12 is a device that generates water vapor. The water vapor generator 12 evaporates water supplied from a water supply tank 30 via a first water supply passage 31, and water supplied from the raw material gas concentration device 14 via a second water supply passage 32. The water supply tank 30 stores, for example, water that is supplied from a water purification facility. The water vapor generated by the water vapor generator 12 is supplied from the water vapor generator 12 to the heater 16 via a water vapor passage 33. A check valve 34 is provided in the water vapor passage 33.

The raw material gas concentration device 14 is a device that serves to concentrate the raw material gas. The raw material gas is carbon dioxide gas. The raw material gas concentration device 14 includes one or more adsorbents whose adsorption capacity for a specified gas within a raw material-containing gas containing the raw material gas that is generated in a raw material gas supply source GS is larger than the adsorption capacity thereof for the raw material gas. The raw material gas supply source GS, for example, is plant equipment or the like.

The raw material gas concentration device 14 separates the moisture within the raw material-containing gas that is supplied from the raw material gas supply source GS via an exhaust gas passage 35. Further, using a pressure swing adsorption method (PSA method), the raw material gas concentration device 14 concentrates the raw material gas within the raw material-containing gas from which the moisture has been separated. The water separated by the raw material gas concentration device 14 is supplied from the raw material gas concentration device 14 via the second water supply passage 32 to the water vapor generator 12. The raw material gas that is concentrated by the raw material gas concentration device 14 is supplied to the heater 16 via a raw material gas discharge passage 36.

The heater 16 is a heating device. In the heater 16, a downstream end portion of the raw material gas discharge passage 36, a downstream end portion of the water vapor passage 33, and an upstream end portion of a mixed gas supply passage 37 are arranged. The upstream end portion of the mixed gas supply passage 37 is connected to the downstream end portion of the raw material gas discharge passage 36 and the downstream end portion of the water vapor passage 33. The raw material gas (carbon dioxide gas) discharged from the raw material gas concentration device 14 into the raw material gas discharge passage 36, and the water vapor discharged from the water vapor generator 12 into the water vapor passage 33 flow into the mixed gas supply passage 37. The heater 16 heats the raw material gas and the water vapor. The raw material gas and the water vapor that have been heated by the heater 16 are supplied via the mixed gas supply passage 37 to the electrolysis device 18.

The electrolysis device 18 is a device that carries out electrolysis on the carbon dioxide gas and the water vapor. The electrolysis device 18 includes a plurality of electrolytic cells 51. Each of the electrolytic cells 51 includes an electrolyte membrane 52, a fuel electrode 53, and an oxygen electrode 54. The electrolyte membrane 52 is sandwiched between the fuel electrode 53 and the oxygen electrode 54. The electrolyte membrane 52 is a solid oxide electrolyte membrane, for example. The fuel electrode 53 may be referred to as a cathode. The oxygen electrode 54 may be referred to as an anode.

The electrolysis device 18 supplies the mixed gas supplied from the mixed gas supply passage 37 to the fuel electrode 53 of each of the electrolytic cells 51. Further, the electrolysis device 18 applies a voltage to the fuel electrode 53 and the oxygen electrode 54 of each of the electrolytic cells 51, and causes an electrical current to flow between the fuel electrode 53 and the oxygen electrode 54. When the electrical current is supplied between the fuel electrode 53 and the oxygen electrode 54, the temperature of the electrolysis device 18 gradually increases.

Accompanying the increase in the temperature of the electrolysis device 18, each of the electrolytic cells 51 begins subjecting the carbon dioxide and the water vapor to electrolysis. When the electrolysis of the carbon dioxide and the water vapor is initiated, carbon monoxide gas and hydrogen gas are generated at the fuel electrode 53, and oxygen gas is generated at the oxygen electrode 54.

The electrolysis device 18 collects an oxygen-containing gas that contains the oxygen gas generated in each of the electrolytic cells 51, and discharges the oxygen-containing gas into an oxygen gas discharge passage 38. Further, the electrolysis device 18 collects a mixed gas containing hydrogen gas and carbon monoxide gas generated in each of the electrolytic cells 51, and discharges the mixed gas into a mixed gas discharge passage 39. The oxygen-containing gas discharged into the oxygen gas discharge passage 38, for example, is supplied to the atmosphere. The mixed gas discharged into the mixed gas discharge passage 39 is supplied to the synthesizing device 20. A check valve 40 is provided in the mixed gas discharge passage 39.

The synthesizing device 20 is a device that synthesizes a hydrocarbon gas from the hydrogen gas and the carbon monoxide gas that are generated by electrolysis in the electrolysis device 18. According to the present embodiment, the hydrocarbon gas is a methane gas. The synthesizing device 20 synthesizes the hydrocarbon gas based on the mixed gas that is supplied from the electrolysis device 18 via the mixed gas discharge passage 39. The synthesizing device 20, for example, using the Fischer-Tropsch method, synthesizes the hydrocarbon gas from the hydrogen gas and the carbon monoxide gas within the mixed gas.

A hydrocarbon-containing gas that contains the hydrocarbon gas synthesized in the synthesizing device 20 is discharged from the synthesizing device 20 into a hydrocarbon gas supply passage 41. The hydrocarbon-containing gas that is discharged into the hydrocarbon gas supply passage 41 is supplied to the hydrocarbon gas concentration device 22.

The hydrocarbon gas concentration device 22 is a device that concentrates the hydrocarbon gas. The hydrocarbon gas concentration device 22 includes one or more adsorbents whose adsorption capacity for specified gases within the hydrocarbon-containing gas is larger than the adsorption capacity thereof for the hydrocarbon gas. According to the present embodiment, the specified gases include hydrogen gas, carbon monoxide gas, and carbon dioxide gas. Using a pressure swing adsorption method (PSA method), the hydrocarbon gas concentration device 22 concentrates the hydrocarbon gas in the hydrocarbon-containing gas, and also individually separates the hydrogen gas, the carbon monoxide gas, and the carbon dioxide from the hydrocarbon-containing gas.

The hydrocarbon gas, which is concentrated by the hydrocarbon gas concentration device 22, is supplied from the hydrocarbon gas concentration device 22, for example, to a hydrocarbon gas tank or the like via a hydrocarbon gas discharge passage 42. The hydrogen gas separated by the hydrocarbon gas concentration device 22 is returned via a hydrogen gas discharge passage 43 from the hydrocarbon gas concentration device 22 to the mixed gas discharge passage 39. The carbon monoxide gas separated by the hydrocarbon gas concentration device 22 is returned via a carbon monoxide gas discharge passage 44 from the hydrocarbon gas concentration device 22 to the mixed gas discharge passage 39. The carbon dioxide gas separated by the hydrocarbon gas concentration device 22 is returned via a carbon dioxide gas discharge passage 45 from the hydrocarbon gas concentration device 22 to the raw material gas discharge passage 36.

The electrosynthesis system 10 according to the present embodiment, in order to increase the heat utilization efficiency, is equipped with a first heat exchanger 61, a second heat exchanger 62, a third heat exchanger 63, and a fourth heat exchanger 64.

A portion of the second water supply passage 32 and a portion of the exhaust gas passage 35 are arranged in the first heat exchanger 61. The first heat exchanger 61 is formed to be capable of exchanging heat between the water flowing through the second water supply passage 32 and the exhaust gas flowing through the exhaust gas passage 35. The water flowing through the second water supply passage 32 is heated, and the raw material-containing gas flowing through the exhaust gas passage 35 is cooled.

A portion of the raw material gas discharge passage 36 and a portion of the oxygen gas discharge passage 38 are arranged in the second heat exchanger 62. The second heat exchanger 62 is formed to be capable of exchanging heat between the raw material gas flowing through the raw material gas discharge passage 36 and the oxygen-containing gas flowing through the oxygen gas discharge passage 38. The raw material gas flowing through the raw material gas discharge passage 36 is heated, and the oxygen-containing gas flowing through the oxygen gas discharge passage 38 is cooled.

A portion of the mixed gas discharge passage 39 and a portion of the water vapor passage 33 are arranged in the third heat exchanger 63. The third heat exchanger 63 is formed to be capable of exchanging heat between the mixed gas flowing through the mixed gas discharge passage 39 and the water vapor flowing through the water vapor passage 33. The mixed gas flowing through the mixed gas discharge passage 39 is cooled, and the water vapor flowing through the water vapor passage 33 is heated.

A portion of the mixed gas discharge passage 39 and a portion of the hydrocarbon gas supply passage 41 are arranged in the fourth heat exchanger 64. The fourth heat exchanger 64 is formed to be capable of exchanging heat between the mixed gas flowing through the mixed gas discharge passage 39 and the hydrocarbon-containing gas flowing through the hydrocarbon gas supply passage 41. The mixed gas flowing through the mixed gas discharge passage 39 is heated, and the hydrocarbon-containing gas flowing through the hydrocarbon gas supply passage 41 is cooled.

The electrosynthesis system 10 according to the present embodiment, in order to increase the water utilization efficiency, is equipped with a first dehumidifier 71, a second dehumidifier 72, a first drain tank 73, a second drain tank 74, and an ion exchange resin 75.

The first dehumidifier 71 is arranged in the mixed gas discharge passage 39 at a location downstream of the third heat exchanger 63. The first dehumidifier 71 extracts moisture within the mixed gas. According to the present embodiment, the first dehumidifier 71 cools the mixed gas and extracts moisture within the mixed gas. The first dehumidifier 71 discharges the moisture extracted from the mixed gas into a first drainage passage 46. The moisture discharged into the first drainage passage 46 is supplied to the first drain tank 73.

The second dehumidifier 72 is arranged in the hydrocarbon gas supply passage 41 at a location downstream of the fourth heat exchanger 64. The second dehumidifier 72 extracts moisture within the hydrocarbon-containing gas. According to the present embodiment, the second dehumidifier 72 cools the hydrocarbon-containing gas and extracts moisture within the hydrocarbon-containing gas. The second dehumidifier 72 discharges the moisture extracted from the hydrocarbon-containing gas into a second drainage passage 47. The moisture discharged into the second drainage passage 47 is supplied to the second drain tank 74.

The first drain tank 73 stores the moisture supplied from the first dehumidifier 71 via the first drainage passage 46. The water stored in the first drain tank 73 is supplied to the ion exchange resin 75 via a third water supply passage 48.

The second drain tank 74 stores the moisture supplied from the second dehumidifier 72 via the second drainage passage 47. The water stored in the second drain tank 74 is supplied to the ion exchange resin 75 via a fourth water supply passage 49.

The ion exchange resin 75 removes unnecessary ions from the water supplied from at least one of the first drain tank 73 or the second drain tank 74. The ion exchange resin 75 may be a cation exchange resin. In this case, dissolved carbonate ions are not removed and can be reused as a raw material. The water from which unnecessary ions have been removed by the ion exchange resin 75 is supplied to the water vapor passage 33 via a fifth water supply passage 50.

The electrosynthesis system 10 according to the present embodiment is further equipped with a primary water supply device 81, a secondary water supply device 82, a first water supply pump 83, a second water supply pump 84, a first blower 85, a second blower 86, and a control device 87.

The primary water supply device 81 is a device that supplies a portion of the water that becomes water vapor to be supplied to the electrolysis device 18. According to the present embodiment, the primary water supply device 81 is a water supply pump. The primary water supply device 81 supplies, to the water vapor generator 12, the water that is stored in the water supply tank 30. A first supply amount, which is the amount of water supplied from the primary water supply device 81, is adjusted by the control device 87.

The secondary water supply device 82 is a device that supplies a portion of the water that becomes water vapor to be supplied to the electrolysis device 18. According to the present embodiment, the secondary water supply device 82 is an injector. The secondary water supply device 82 supplies, to the water vapor passage 33 as mist, the water that is supplied from the ion exchange resin 75. The water supplied from the ion exchange resin 75 is water that is extracted by the first dehumidifier 71 or the second dehumidifier 72. A second supply amount, which is the amount of water supplied from the secondary water supply device 82, is adjusted by the control device 87.

The first water supply pump 83 supplies the water that is stored in the first drain tank 73 to the ion exchange resin 75. The amount of water supplied from the first water supply pump 83 may be adjusted by the control device 87, or may be fixed.

The second water supply pump 84 supplies the water that is stored in the second drain tank 74 to the ion exchange resin 75. The amount of water supplied from the second water supply pump 84 may be adjusted by the control device 87, or may be fixed.

The first blower 85 supplies the exhaust gas containing the raw material gas discharged from the raw material gas supply source GS to the exhaust gas passage 35. The amount of the raw material-containing gas supplied from the first blower 85 is adjusted by the control device 87.

The second blower 86 supplies hydrocarbon-containing gas from the hydrocarbon gas supply passage 41 to the hydrocarbon gas concentration device 22. The amount of the hydrocarbon-containing gas supplied from the second blower 86 is adjusted by the control device 87.

The control device 87 is a computer that controls the electrosynthesis system 10. The control device 87 is equipped with an operation unit, a storage unit, and a computation unit. The operation unit is an input device that is capable of receiving instructions from an operator. The storage unit may be constituted by a volatile memory and a nonvolatile memory. As an example of the volatile memory, there may be cited a RAM or the like. As an example of the nonvolatile memory, there may be cited a ROM, a flash memory, or the like. The computation unit includes a processor such as a CPU, an MPU, or the like.

Based on various detection results detected by a group of sensors, the control device 87 controls various devices included in the electrosynthesis system 10. The various devices included in the electrosynthesis system 10 include the water vapor generator 12, the raw material gas concentration device 14, the heater 16, the electrolysis device 18, the synthesizing device 20, the hydrocarbon gas concentration device 22, the primary water supply device 81, the secondary water supply device 82, the first water supply pump 83, the second water supply pump 84, the first blower 85, and the second blower 86. In the group of sensors, there are included a first analyzer 91, a second analyzer 92, and a temperature sensor 93.

The first analyzer 91 is provided in the mixed gas discharge passage 39 in close proximity to the electrolysis device 18. The first analyzer 91 includes a hydrogen gas concentration sensor, a carbon monoxide gas concentration sensor, and a concentration ratio calculation unit. The hydrogen gas concentration sensor detects the concentration of the hydrogen gas within the mixed gas. The carbon monoxide gas concentration sensor detects the concentration of the carbon monoxide gas within the mixed gas. The concentration ratio calculation unit calculates a first concentration ratio, which is a concentration ratio between the hydrogen gas and the carbon monoxide gas. According to the present embodiment, the concentration ratio (H₂/CO) of the hydrogen gas (H₂) to the carbon monoxide gas (CO) is calculated as the first concentration ratio. However, the concentration ratio (CO/H₂) of the carbon monoxide gas (CO) to the hydrogen gas (H₂) may be calculated as the first concentration ratio.

The second analyzer 92 is provided in the mixed gas supply passage 37 in close proximity to the electrolysis device 18. The second analyzer 92 includes a carbon dioxide gas concentration sensor, a water vapor concentration sensor, and a concentration ratio calculation unit. The carbon dioxide gas concentration sensor detects the concentration of the carbon dioxide gas within the mixed gas. The water vapor concentration sensor detects the concentration of the water vapor in the mixed gas. The concentration ratio calculation unit calculates a second concentration ratio, which is a concentration ratio between the carbon dioxide gas and the water vapor. According to the present embodiment, the concentration ratio (H₂O/CO₂) of the water vapor (H₂O) to the carbon dioxide gas (CO₂) is calculated as the second concentration ratio. However, the concentration ratio (CO₂/H₂O) of the carbon dioxide gas (CO₂) to the water vapor (H₂O) may be calculated as the second concentration ratio.

The temperature sensor 93 is provided outdoors. For example, the temperature sensor 93 is provided on an outer wall of the water supply tank 30 that is installed outdoors. The temperature sensor 93 detects the outside air temperature. The outside air temperature is the temperature outdoors.

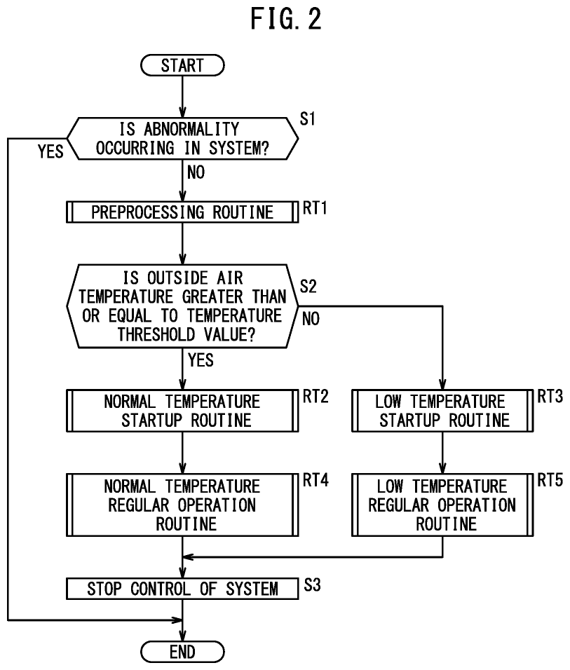

Upon receiving a command from the operation unit to start the electrosynthesis system 10, the control device 87 executes the system control process. FIG. 2 is a flowchart showing the procedure of the system control process.

In step S1, the control device 87 determines whether or not an abnormality has occurred in the electrosynthesis system 10. Whether or not an abnormality has occurred in the electrosynthesis system 10 is determined based on an abnormality signal that indicates that there is an abnormality in the electrosynthesis system 10. The abnormality signal is generated, for example, in the case that a constituent element of the electrosynthesis system 10 has failed, and the abnormality signal is supplied to the control device 87. In the case it is determined that an abnormality has occurred in the electrosynthesis system 10, the system control process comes to an end. On the other hand, in the case it is determined that an abnormality has not occurred in the electrosynthesis system 10, the system control process transitions to a preprocessing routine RT1.

In the preprocessing routine RT1, the control device 87 executes preprocessing for supplying the carbon dioxide gas and the water vapor to the electrolysis device 18. Details of the preprocessing routine RT1 will be described later. When the preprocessing routine RT1 ends, the system control process transitions to step S2.

In step S2, the control device 87 compares the outside air temperature detected by the temperature sensor 93 with a predetermined temperature threshold value. The temperature threshold value, for example, is set to 5° C. In the case that the outside air temperature is greater than or equal to the temperature threshold value, the system control process transitions to a normal temperature startup routine RT2. In the case that the outside air temperature is less than the temperature threshold value, the system control process transitions to a low temperature startup routine RT3.

In the normal temperature startup routine RT2, the control device 87 uses the second analyzer 92 and thereby adjusts the first supply amount of the primary water supply device 81 with priority over the second supply amount of the secondary water supply device 82. Details of the normal temperature startup routine RT2 will be described later. When the normal temperature startup routine RT2 ends, the system control process transitions to a normal temperature regular operation routine RT4.

In the low temperature startup routine RT3, the control device 87 uses the second analyzer 92 and thereby adjusts the second supply amount of the secondary water supply device 82 with priority over the first supply amount of the primary water supply device 81. Details of the low temperature startup routine RT3 will be described later. When the low temperature startup routine RT3 ends, the system control process transitions to a low temperature regular operation routine RT5.

In the normal temperature regular operation routine RT4, using the first analyzer 91, the control device 87 executes a feedback control and thereby adjusts the second supply amount of the secondary water supply device 82, in a manner so that the concentration ratio of the gas composition on the downstream side of the electrolysis device 18 is maintained at a target concentration ratio. Details of the normal temperature regular operation routine RT4 will be described later. The feedback control of the normal temperature regular operation routine RT4 is executed until a stop command is given to the control device 87. When the stop command is given to the control device 87, the system control process transitions to step S3.

In the low temperature regular operation routine RT5, using the first analyzer 91, the control device 87 executes a feedback control and thereby adjusts the first supply amount of the primary water supply device 81, in a manner so that the concentration ratio of the gas composition on the downstream side of the electrolysis device 18 is maintained at the target concentration ratio. Details of the low temperature regular operation routine RT5 will be described later. The feedback control of the low temperature regular operation routine RT5 is executed until a stop command is given to the control device 87. When the stop command is given to the control device 87, the system control process transitions to step S3.

In step S3, the control device 87 stops controlling the various devices included in the electrosynthesis system 10. Further, the control device 87 stores necessary items of information in the storage unit. When the control of the electrosynthesis system 10 is stopped and the necessary items of information are stored in the storage unit, the system control process comes to an end.

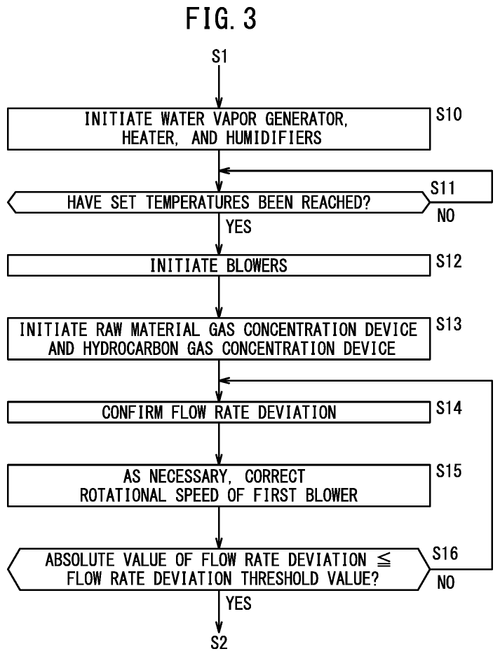

FIG. 3 is a flowchart showing the procedure of the preprocessing routine RT1. The preprocessing routine RT1 is initiated in the case it is determined in step S1 that an abnormality has not occurred in the electrosynthesis system 10.

In step S10, the control device 87 initiates the water vapor generator 12, the heater 16, the first dehumidifier 71, and the second dehumidifier 72. In response to the initiation thereof, the temperature of the water vapor generator 12 and the heater 16 gradually rises. On the other hand, the temperature of the first dehumidifier 71 and the second dehumidifier 72 gradually lowers. When the water vapor generator 12, the heater 16, the first dehumidifier 71, and the second dehumidifier 72 are initiated, the system control process transitions to step S11.

In step S11, the control device 87 compares the temperatures of the water vapor generator 12, the heater 16, the first dehumidifier 71, and the second dehumidifier 72 with set temperatures. The temperatures of the water vapor generator 12, the heater 16, the first dehumidifier 71, and the second dehumidifier 72 are detected by sensors (not shown) provided in the water vapor generator 12, the heater 16, the first dehumidifier 71, and the second dehumidifier 72, respectively. The set temperatures are different for each of the water vapor generator 12, the heater 16, the first dehumidifier 71, and the second dehumidifier 72.

In the case that the temperatures of the water vapor generator 12, the heater 16, the first dehumidifier 71, and the second dehumidifier 72 have not reached the set temperatures, the system control process remains at step S11. In the case that the temperatures of the water vapor generator 12, the heater 16, the first dehumidifier 71, and the second dehumidifier 72 have reached the set temperatures, the system control process transitions to step S12.

In step S12, the control device 87 initiates the first blower 85, and starts supplying the raw material-containing gas to the raw material gas concentration device 14 from the raw material gas supply source GS. Further, the control device 87 initiates the second blower 86, and starts supplying the hydrocarbon-containing gas to the hydrocarbon gas concentration device 22 from the hydrocarbon gas supply passage 41. When the first blower 85 and the second blower 86 are initiated, the system control process transitions to step S13.

In step S13, the control device 87 initiates the raw material gas concentration device 14 and the hydrocarbon gas concentration device 22. When the raw material gas concentration device 14 is initiated, the supply of the raw material gas to the electrolysis device 18 starts. The raw material gas is supplied to the electrolysis device 18 via the raw material gas discharge passage 36 and the mixed gas supply passage 37 in this order. Moreover, it should be noted that when the raw material gas concentration device 14 is initiated, a small amount of the water vapor starts to be supplied secondarily prior to the primary supply of the water vapor to the electrolysis device 18. The water vapor is supplied to the electrolysis device 18 via the second water supply passage 32, the water vapor generator 12, the water vapor passage 33, and the mixed gas supply passage 37 in this order. When the raw material gas concentration device 14 and the hydrocarbon gas concentration device 22 are initiated, the system control process transitions to step S14.

In step S14, the control device 87 confirms a flow rate deviation, which is the deviation of a detected flow rate of the raw material gas from a reference flow rate of the raw material gas. The control device 87 calculates the flow rate deviation by subtracting the detected flow rate of the raw material gas from the reference flow rate of the raw material gas that is determined in advance. The flow rate deviation assumes a positive value or a negative value. The detected flow rate is a flow rate detected by a flow rate sensor (not shown) provided in the raw material gas discharge passage 36. When the flow rate deviation of the raw material gas is confirmed, the system control process transitions to step S15.

In step S15, the control device 87 corrects the rotational speed of the first blower 85. In the case that the flow rate deviation of the raw material gas assumes a positive value, the control device 87 lowers the rotational speed of the first blower 85 by an amount corresponding to the number of rotations corresponding to the flow rate deviation. In this case, the amount of the raw material-containing gas supplied from the raw material gas supply source GS to the raw material gas concentration device 14 decreases. On the other hand, in the case that the flow rate deviation of the raw material gas assumes a negative value, the control device 87 raises the rotational speed of the first blower 85 by an amount corresponding to the number of rotations corresponding to the flow rate deviation. In this case, the amount of the raw material-containing gas supplied from the raw material gas supply source GS to the raw material gas concentration device 14 increases. Moreover, it should be noted that, in the case there is not a flow rate deviation of the raw material gas (in the case that the flow rate deviation of the raw material gas is zero), the control device 87 does not correct the rotational speed of the first blower 85. After the rotational speed of the first blower 85 has been corrected in accordance with the presence or absence of the flow rate deviation of the raw material gas, the system control process transitions to step S16.

In step S16, the control device 87 compares an absolute value of the flow rate deviation of the raw material gas with a predetermined flow rate deviation threshold value. In the case that the absolute value of the flow rate deviation of the raw material gas is not less than or equal to the flow rate deviation threshold value, the system control process returns to step S14. On the other hand, in the case that the absolute value of the flow rate deviation of the raw material gas is less than or equal to the flow rate deviation threshold value, the system control process returns to step S2 (see FIG. 2).

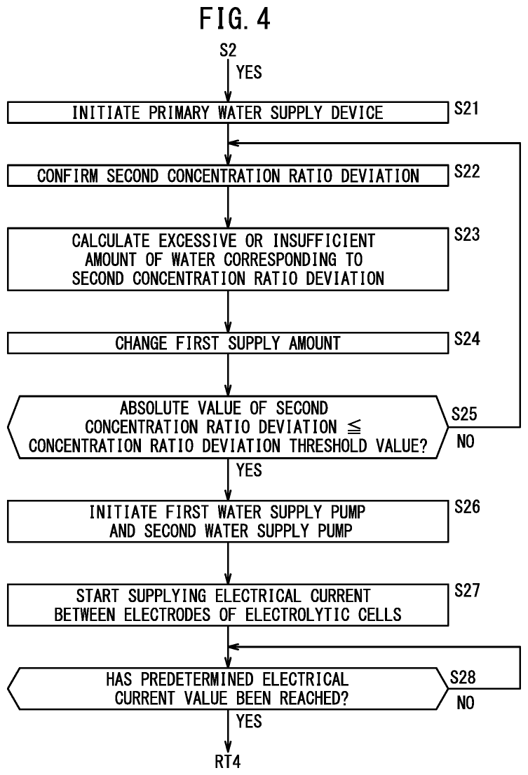

FIG. 4 is a flowchart showing the procedure of the normal temperature startup routine RT2. The normal temperature startup routine RT2 is initiated in the case that a comparison result in which the outside air temperature is greater than or equal to the temperature threshold value is obtained in step S2. In the case that the outside air temperature is greater than or equal to the temperature threshold value, there is no possibility that a sufficient amount of the water vapor cannot be supplied to the electrolysis device 18 due to freezing of the water that is stored in the water supply tank 30. Therefore, the water that is stored in the water supply tank 30, which is less likely to be depleted in comparison with the water in the first drain tank 73 and the second drain tank 74, is primarily used.

In step S21, the control device 87 initiates the primary water supply device 81, and starts supplying the water to the water vapor generator 12. The water supplied to the water vapor generator 12 becomes water vapor, and is supplied to the electrolysis device 18 via the water vapor passage 33 and the mixed gas supply passage 37 in this order. By initiating the primary water supply device 81, the primary supply of the water vapor to the electrolysis device 18 is started. When the primary water supply device 81 is initiated, the system control process transitions to step S22.

In step S22, the control device 87 confirms a second concentration ratio deviation, which is a deviation of the second concentration ratio from a predetermined target concentration ratio. According to the present embodiment, methane gas is synthesized from the hydrogen gas and the carbon monoxide gas in the synthesizing device 20. Therefore, according to the present embodiment, the target concentration ratio is “3”. The control device 87 subtracts the second concentration ratio measured by the second analyzer 92 from the predetermined target concentration ratio, and thereby calculates the second concentration ratio deviation. The second concentration ratio deviation assumes a positive value or a negative value. When the second concentration ratio deviation is confirmed, the system control process transitions to step S23.

In step S23, the control device 87 calculates an amount of water corresponding to the second concentration ratio deviation. In other words, the control device 87 converts the result of subtracting the second concentration ratio from the target concentration ratio into the amount of water. In the case that the second concentration ratio deviation assumes a positive value, the control device 87 calculates an excessive amount of the water. On the other hand, in the case that the second concentration ratio deviation assumes a negative value, the control device 87 calculates an insufficient amount of the water. In calculating the amount of water, a predetermined function is used in which the larger the absolute value of the second concentration ratio deviation becomes, the larger the amount of water becomes. When the amount of water corresponding to the second concentration ratio deviation is calculated, the system control process transitions to step S24.

In step S24, based on the amount of water corresponding to the second concentration ratio deviation, the control device 87 changes the first supply amount of the primary water supply device 81 from an initial amount of water. According to the present embodiment, the primary water supply device 81 is a water supply pump. Therefore, by controlling the rotational speed of a water delivery motor in the water supply pump, the control device 87 changes the first supply amount of the primary water supply device 81.

In the case that an excessive amount of water is calculated as the amount of water corresponding to the second concentration ratio deviation, the control device 87 lowers the rotational speed of the water delivery motor by an amount corresponding to the number of rotations corresponding to the excessive amount of water, and reduces the first supply amount. In the case that an insufficient amount of water is calculated as the amount of water corresponding to the second concentration ratio deviation, the control device 87 raises the rotational speed of the water delivery motor by an amount corresponding to the number of rotations corresponding to the insufficient amount of water, and increases the first supply amount of the primary water supply device 81.

The initial amount of water may be a fixed default value determined in advance. Alternatively, the initial amount of water may be the first supply amount of the primary water supply device 81 at a time of a previous stopping of operation of the electrosynthesis system 10. In this case, the first supply amount of the primary water supply device 81 at the time of the previous stopping of operation of the electrosynthesis system 10 is stored in the storage unit in step S3 (see FIG. 2). According to the present embodiment, the primary water supply device 81 is a water supply pump. Therefore, the rotational speed of the water delivery motor in the water supply pump is stored in the storage unit as the first supply amount of the primary water supply device 81 at the time of the previous stopping of operation of the electrosynthesis system 10. When the first supply amount of the primary water supply device 81 is changed, the system control process transitions to step S25.

In step S25, the control device 87 compares an absolute value of the second concentration ratio deviation with a predetermined concentration ratio deviation threshold value. In the case that the absolute value of the second concentration ratio deviation is not less than or equal to the concentration ratio deviation threshold value, the system control process returns to step S22. On the other hand, in the case that the absolute value of the second concentration ratio deviation is less than or equal to the concentration ratio deviation threshold value, the system control process transitions to step S26.

In step S26, the control device 87 initiates the first water supply pump 83 and the second water supply pump 84, and starts supplying the water to the ion exchange resin 75. When the first water supply pump 83 and the second water supply pump 84 are initiated, the system control process transitions to step S27.

In step S27, the control device 87 starts supplying an electrical current between the fuel electrode 53 and the oxygen electrode 54 of the electrolytic cells 51. When the supply of electrical current between the electrodes of the electrolytic cells 51 is started, the system control process transitions to step S28.

In step S28, using an electrical current sensor or a voltage sensor provided in the electrolysis device 18, the control device 87 monitors an electrical current value of the electrical current supplied between the electrodes of the electrolytic cells 51. In the case that the electrical current supplied between the electrodes of the electrolytic cells 51 has not reached a predetermined electrical current value, the electrolytic reaction in the electrolytic cells 51 may easily become unstable. Therefore, in the case that the electrical current supplied between the electrodes of the electrolytic cells 51 has not reached the predetermined electrical current value, the system control process remains at step S28. On the other hand, when the electrical current supplied between the electrodes of the electrolytic cells 51 has reached the predetermined electrical current value, the electrolytic reaction in the electrolytic cells 51 becomes stable. In this case, the system control process transitions to the normal temperature regular operation routine RT4 (see FIG. 2).

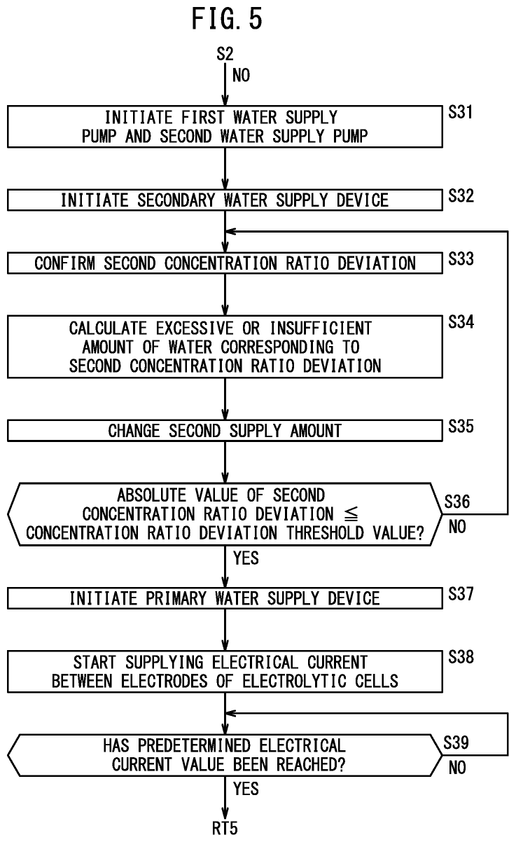

FIG. 5 is a flowchart showing the procedure of the low temperature startup routine RT3. The low temperature startup routine RT3 is initiated in the case that a comparison result in which the outside air temperature is less than the temperature threshold value is obtained in step S2. In the case that the outside air temperature is less than the temperature threshold value, a possibility exists that a sufficient amount of the water vapor cannot be supplied to the electrolysis device 18 due to freezing of the water that is stored in the water supply tank 30. Therefore, the water stored in the first drain tank 73 and the second drain tank 74, which is less likely to freeze in comparison with the water in the water supply tank 30, is primarily used.

In step S31, the control device 87 initiates the first water supply pump 83 and the second water supply pump 84, and starts supplying the water to the ion exchange resin 75. When the first water supply pump 83 and the second water supply pump 84 are initiated, the system control process transitions to step S32.

In step S32, the control device 87 initiates the secondary water supply device 82, and starts supplying the water to the water vapor passage 33. The water supplied to the water vapor passage 33 is heated by the heater 16 and thereby becomes water vapor, and the water vapor is supplied to the electrolysis device 18 via the mixed gas supply passage 37. By initiating the secondary water supply device 82, the primary supply of the water vapor to the electrolysis device 18 is started. According to the present embodiment, the secondary water supply device 82 is an injector. Therefore, the control device 87 opens the valve in the injector for a predetermined valve opening time period at a predetermined valve opening interval, and thereby supplies the water to the water vapor passage 33. When the secondary water supply device 82 is initiated, the system control process transitions to step S33.

In step S33, in the same manner as in step S22 (see FIG. 4), the control device 87 confirms the second concentration ratio deviation. When the second concentration ratio deviation is confirmed, the system control process transitions to step S34.

In step S34, in the same manner as in step S23 (see FIG. 4), the control device 87 calculates an amount of water corresponding to the second concentration ratio deviation. When the amount of water corresponding to the second concentration ratio deviation is calculated, the system control process transitions to step S35.

In step S35, based on the amount of water corresponding to the second concentration ratio deviation, the control device 87 changes the second supply amount of the secondary water supply device 82 from an initial amount of water. According to the present embodiment, the secondary water supply device 82 is an injector. Therefore, by controlling at least one of the valve opening interval or the valve opening time period of the valve in the injector, the control device 87 changes the second supply amount of the secondary water supply device 82.

In the case that an excessive amount of water is calculated as the amount of water corresponding to the second concentration ratio deviation, the control device 87 shortens the opening time period of the valve in the injector by an amount of time corresponding to the excessive amount of the water, for example, and reduces the second supply amount of the secondary water supply device 82. On the other hand, in the case that an insufficient amount of water is calculated as the amount of water corresponding to the second concentration ratio deviation, the control device 87 lengthens the opening time period of the valve in the injector by an amount of time corresponding to the insufficient amount of the water, and increases the second supply amount of the secondary water supply device 82.

The initial amount of water of the second supply amount may be a fixed default value determined in advance. Alternatively, the initial amount of water of the second supply amount may be the second supply amount of the secondary water supply device 82 at a time of a previous stopping of operation of the electrosynthesis system 10. In this case, the second supply amount of the secondary water supply device 82 at the time of the previous stopping of operation of the electrosynthesis system 10 is stored in the storage unit in step S3 (see FIG. 2). According to the present embodiment, the secondary water supply device 82 is an injector. Therefore, at least one of the valve opening interval or the valve opening time period of the valve in the injector is stored in the storage unit as the second supply amount of the secondary water supply device 82 at the time of the previous stopping of operation of the electrosynthesis system 10. When the second supply amount of the secondary water supply device 82 is changed, the system control process transitions to step S36.

In step S36, in the same manner as in step S25 (see FIG. 4), the control device 87 compares an absolute value of the second concentration ratio deviation with a predetermined concentration ratio deviation threshold value. In the case that the absolute value of the second concentration ratio deviation is not less than or equal to the concentration ratio deviation threshold value, the system control process returns to step S33. On the other hand, in the case that the absolute value of the second concentration ratio deviation is less than or equal to the concentration ratio deviation threshold value, the system control process transitions to step S37.

In step S37, the control device 87 initiates the primary water supply device 81, and starts supplying the water to the water vapor generator 12. When the primary water supply device 81 is initiated, the system control process transitions to step S38.

In step S38, in the same manner as in step S27 (see FIG. 4), the control device 87 starts supplying an electrical current between the fuel electrode 53 and the oxygen electrode 54 of the electrolytic cells 51. When the supply of electrical current between the electrodes of the electrolytic cells 51 is started, the system control process transitions to step S39.

In step S39, in the same manner as in step S28 (see FIG. 4), the control device 87 monitors an electrical current value of the electrical current supplied between the electrodes of the electrolytic cells 51. In the case that the electrical current supplied between the electrodes of the electrolytic cells 51 has not reached a predetermined electrical current value, the system control process remains at step S39. On the other hand, when the electrical current supplied between the electrodes of the electrolytic cells 51 has reached the predetermined electrical current value, the system control process transitions to the low temperature regular operation routine RT5 (see FIG. 2).

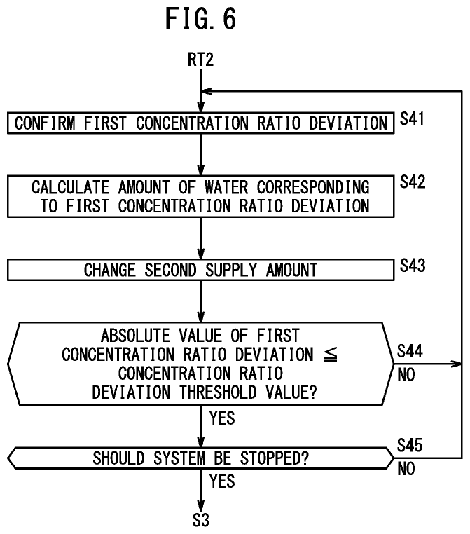

FIG. 6 is a flowchart showing the procedure of the normal temperature regular operation routine RT4. The normal temperature regular operation routine RT4 is initiated after the electrical current supplied between the electrodes of the electrolytic cells 51 has reached the predetermined electrical current value in step S28 (see FIG. 4).

In step S41, the control device 87 confirms a first concentration ratio deviation, which is a deviation of the first concentration ratio from a predetermined target concentration ratio. The control device 87 subtracts the first concentration ratio measured by the first analyzer 91 from the predetermined target concentration ratio, and thereby calculates the first concentration ratio deviation. The first concentration ratio deviation assumes a positive value or a negative value. When the first concentration ratio deviation is confirmed, the system control process transitions to step S42.

In step S42, the control device 87 calculates an amount of water corresponding to the first concentration ratio deviation. In other words, the control device 87 converts the result of subtracting the first concentration ratio from the target concentration ratio into the amount of water. In the case that the first concentration ratio deviation assumes a positive value, the control device 87 calculates an excessive amount of the water. On the other hand, in the case that the first concentration ratio deviation assumes a negative value, the control device 87 calculates an insufficient amount of the water. In calculating the amount of water, a predetermined function is used in which the larger the absolute value of the first concentration ratio deviation becomes, the larger the amount of water becomes. When the amount of water corresponding to the first concentration ratio deviation is calculated, the system control process transitions to step S43.

In step S43, based on the amount of water corresponding to the first concentration ratio deviation, the control device 87 changes the second supply amount of the secondary water supply device 82 from the initial amount of water. The second supply amount of the secondary water supply device 82 is changed in the same manner as the case described above in step S35 (see FIG. 5). When the second supply amount of the secondary water supply device 82 is changed, the system control process transitions to step S44.

In step S44, the control device 87 compares an absolute value of the first concentration ratio deviation with a predetermined concentration ratio deviation threshold value. In the case that the absolute value of the first concentration ratio deviation exceeds the concentration ratio deviation threshold value, the system control process returns to step S41. In the case that the absolute value of the first concentration ratio deviation is less than or equal to the concentration ratio deviation threshold value, the system control process transitions to step S45.

In step S45, the control device 87 determines whether or not to stop the electrosynthesis system 10. In the case that a stop command is not given to the control device 87, the system control process returns to step S41. On the other hand, in the case that the stop command is given to the control device 87, the system control process transitions to step S3.

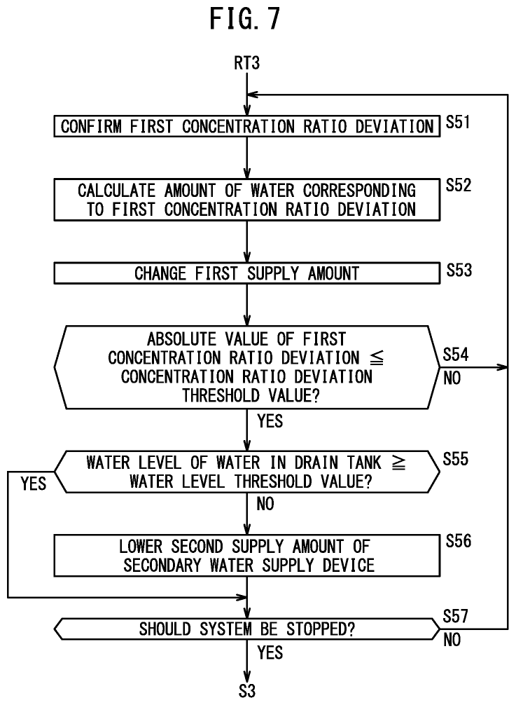

FIG. 7 is a flowchart showing the procedure of the low temperature regular operation routine RT5. The low temperature regular operation routine RT5 is initiated after the electrical current supplied between the electrodes of the electrolytic cells 51 has reached the predetermined electrical current value in step S39 (see FIG. 5).

In step S51, in the same manner as in step S41 (see FIG. 6), the control device 87 confirms the first concentration ratio deviation. When the first concentration ratio deviation is confirmed, the system control process transitions to step S52.

In step S52, in the same manner as in step S42 (see FIG. 6), the control device 87 calculates an amount of water corresponding to the first concentration ratio deviation. When the amount of water corresponding to the first concentration ratio deviation is calculated, the system control process transitions to step S53.

In step S53, based on the amount of water corresponding to the first concentration ratio deviation, the control device 87 changes the first supply amount of the primary water supply device 81. The first supply amount of the primary water supply device 81 is changed in the same manner as the case described above in step S24 (see FIG. 4). When the first supply amount of the primary water supply device 81 is changed, the system control process transitions to step S54.

In step S54, the control device 87 compares an absolute value of the first concentration ratio deviation with a predetermined concentration ratio deviation threshold value. In the case that the absolute value of the first concentration ratio deviation exceeds the concentration ratio deviation threshold value, the system control process returns to step S51. In the case that the absolute value of the first concentration ratio deviation is less than or equal to the concentration ratio deviation threshold value, the system control process transitions to step S55.

In step S55, the control device 87 compares the water level of the water that is stored in the first drain tank 73 and the water level of the water that is stored in the second drain tank 74 with a predetermined water level threshold value. The reason for this comparison is that, in the low temperature startup routine RT3, the water (drain water) that is stored in the first drain tank 73 and the second drain tank 74 is continuously supplied from prior to when the water stored in the water supply tank 30 is supplied. (see FIG. 5).

The water level of the water that is stored in the first drain tank 73 is detected by a first water level sensor disposed in the interior of the first drain tank 73. The water level of the water that is stored in the second drain tank 74 is detected by a second water level sensor disposed in the interior of the second drain tank 74. The same water level threshold value may be used for the first drain tank 73 and the second drain tank 74. Alternatively, the water level threshold value may be different for each of the first drain tank 73 and the second drain tank 74.

In the case that the water level of the water in at least one of the first drain tank 73 or the second drain tank 74 is greater than or equal to the water level threshold value, the system control process transitions to step S57. On the other hand, in the case that the water levels of the water in both of the first drain tank 73 and the second drain tank 74 are less than the water level threshold value, the system control process transitions to step S56.

In step S56, the control device 87 lowers the second supply amount of the secondary water supply device 82. The control device 87 may also stop the secondary water supply device 82. In the case that the second supply amount of the secondary water supply device 82 is lowered, the control device 87 may increase the first supply amount of the primary water supply device 81 by the amount of water lowered for the secondary water supply device 82. When the second supply amount of the secondary water supply device 82 is lowered, the system control process transitions to step S57.

In step S57, the control device 87 determines whether or not to stop the electrosynthesis system 10. In the case that a stop command is not given to the control device 87, the system control process returns to step S51. On the other hand, in the case that the stop command is given to the control device 87, the system control process transitions to step S3.

As noted previously, according to the present embodiment, the control device 87 adjusts the flow rate of the water vapor supplied to the electrolysis device 18, in a manner so that the gas composition ratio (the first concentration ratio) on the downstream side of the electrolysis device 18 becomes the predetermined target concentration ratio. Consequently, the hydrogen gas and the carbon monoxide gas can be supplied at the appropriate concentration ratio to the synthesizing device 20. As a result, hydrocarbon gas can be stably synthesized without waste.

In the electrolysis device 18, the electrolytic reaction of the electrolysis device 18 may easily become unstable, until the electrical current supplied between the electrodes of the electrolysis device 18 reaches the predetermined electrical current value. According to the present embodiment, until the electrical current supplied to the electrolysis device 18 reaches the predetermined electrical current value, the control device 87 adjusts the flow rate of the water vapor supplied to the electrolysis device 18 based on the gas composition ratio (the second concentration ratio) on the upstream side of the electrolysis device 18. Consequently, even if the electrolytic reaction of the electrolysis device 18 is unstable, the gas composition ratio on the downstream side of the electrolysis device 18 can be brought closer to the target concentration ratio.

Further, according to the present embodiment, there are provided the primary water supply device 81 that supplies the water to the water vapor generator 12, and the secondary water supply device 82 that supplies the water to the water vapor passage 33 that places the water vapor generator 12 and the heater 16 in communication. The control device 87 controls the first supply amount of the primary water supply device 81 and the second supply amount of the secondary water supply device 82, and thereby adjusts the flow rate of the water vapor supplied from the heater 16 to the electrolysis device 18. Consequently, the supply of the water vapor to the electrolysis device 18 can be made more stable in comparison with a case in which the supply system is only one system.

Further, according to the present embodiment, there are provided the first dehumidifier 71 that extracts the moisture within the mixed gas that is discharged from the electrolysis device 18, and the second dehumidifier 72 that extracts the moisture within the hydrocarbon-containing gas that is discharged from the synthesizing device 20. The secondary water supply device 82 supplies the water extracted by the first dehumidifier 71 or the second dehumidifier 72. In accordance with such features, the water utilization efficiency can be increased.

Further, according to the present embodiment, the control device 87 switches between adjusting the first supply amount of the primary water supply device 81, and adjusting the second supply amount of the secondary water supply device 82, in accordance with the outside air temperature that is detected by the temperature sensor 93. In accordance with this feature, a situation can be prevented in which supplying of the water vapor to the electrolysis device 18 becomes impossible due to freezing of the water at a time of low temperature.

Further, according to the present embodiment, in the case that the outside air temperature detected by the temperature sensor 93 is less than or equal to the predetermined temperature threshold value, the control device 87 adjusts the second supply amount with priority over the first supply amount. In accordance with this feature, even if the outside air temperature is low, the water recovered by the first dehumidifier 71 or the second dehumidifier 72 can be supplied to the electrolysis device 18 in the form of water vapor via the heater 16. As a result, even if the water supplied to the water vapor generator 12 freezes, the water vapor is capable of being supplied to the electrolysis device 18.

### [Modifications]

The above-described embodiment may be modified in the following manner.

### (Modification 1)

In the normal temperature regular operation routine RT4 (see FIG. 6), the control device 87 may monitor the water levels of the water that is stored in the first drain tank 73 and the second drain tank 74. For example, the control device 87 compares the water level of the water that is stored in the first drain tank 73 and the water level of the water that is stored in the second drain tank 74 with the predetermined water level threshold value.

In the case that the water levels of the water in both of the first drain tank 73 and the second drain tank 74 are less than the water level threshold value, the control device 87 switches from controlling the second supply amount of the secondary water supply device 82 to controlling the first supply amount of the primary water supply device 81. Thereafter, when the water level of the water in at least one of the first drain tank 73 or the second drain tank 74 becomes greater than or equal to the water level threshold value, the control device 87 returns from controlling the first supply amount of the primary water supply device 81 to controlling the first supply amount of the secondary water supply device 82.

Consequently, compared to a case in which the water levels of the water that is stored in the first drain tank 73 and the second drain tank 74 are not monitored, the water vapor can be supplied in a more stable manner to the electrolysis device 18.

### (Modification 2)

The control device 87 may switch the distribution between the first supply amount of the primary water supply device 81 and the second supply amount of the secondary water supply device 82 in accordance with the outside air temperature.

In the case that the outside air temperature is not less than or equal to the predetermined temperature threshold value, there is no possibility that the water in the water supply tank 30, which has a higher water supply capacity than the first drain tank 73 and the second drain tank 74, will freeze. In this case, the control device 87 makes the distribution of the first supply amount of the primary water supply device 81 larger than that of the second supply amount of the secondary water supply device 82. For example, in the case that the amount of water that becomes water vapor that is supplied to the electrolysis device 18 is “10”, the control device 87 sets the first supply amount of the water from the primary water supply device 81 to “9”, and sets the second supply amount of the water from the secondary water supply device 82 to “1”.

On the other hand, in the case that the outside air temperature is less than or equal to the predetermined temperature threshold value, the control device 87 makes the distribution of the second supply amount of the secondary water supply device 82 larger than that of the first supply amount of the primary water supply device 81. For example, in the case that the amount of water that becomes water vapor that is supplied to the electrolysis device 18 is “10”, the control device 87 sets the first supply amount of the water from the primary water supply device 81 to “4”, and sets the second supply amount of the water from the secondary water supply device 82 to “6”.

Consequently, compared to a case in which the distribution between the first supply amount of the primary water supply device 81 and the second supply amount of the secondary water supply device 82 is not switched, the water vapor can be supplied in a more stable manner to the electrolysis device 18.

### (Modification 3)

The control device 87 may adjust the flow rate of the carbon dioxide gas that is supplied to the electrolysis device 18. For example, the control device 87 controls the degree of opening of a flow rate adjustment valve provided in the raw material gas discharge passage 36, and thereby adjusts the flow rate of the carbon dioxide gas supplied to the electrolysis device 18.

In the normal temperature startup routine RT2 or the low temperature startup routine RT3, the control device 87 uses the second analyzer 92, and thereby controls the degree of opening of the flow rate adjustment valve provided in the raw material gas discharge passage 36. Further, in the normal temperature regular operation routine RT4 or the low temperature regular operation routine RT5, the control device 87 uses the first analyzer 91, and thereby feedback controls the degree of opening of the flow rate adjustment valve.

Moreover, is should be noted that, in the case of controlling the degree of opening of the flow rate adjustment valve provided in the raw material gas discharge passage 36, the control device 87 may control the electrical current value of the electrical current that is supplied to the electrolysis device 18. For example, as the degree of opening of the flow rate adjustment valve increases, the control device 87 increases the electrical current value of the electrical current supplied to the electrolysis device 18.

### (Modification 4)

The target concentration ratio between the hydrogen gas (or the water vapor) and the carbon monoxide gas (or the carbon dioxide gas) is not limited to being “3:1” as in the above-described embodiment. For example, in the case that methanol is synthesized in the synthesizing device 20, the chemical reaction formula is “CO+2H₂->CH₃OH”. In this case, the target concentration ratio becomes “2:1”. Further, for example, in the case that ethyl alcohol is synthesized in the synthesizing device 20, the chemical reaction formula is “3H₂O+2CO₂->C₂H₅OH+3O₂”. In this case, the target concentration ratio becomes “3:2”.

### [Invention]

The invention and the advantageous effects that are capable of being grasped from the above description will be described below.

(1) The present invention is the electrosynthesis system (10) including the electrolysis device (18) that carries out electrolysis on the carbon dioxide gas and the water vapor, and the synthesizing device (20) that synthesizes the hydrocarbon gas from the hydrogen gas and the carbon monoxide gas that are generated by the electrolysis. The electrosynthesis system includes the first analyzer (91) that measures the first concentration ratio, which is the concentration ratio between the hydrogen gas and the carbon monoxide gas in the mixed gas discharged from the electrolysis device and containing the hydrogen gas and the carbon monoxide gas, and the control device (87) that adjusts the flow rate of the water vapor supplied to the electrolysis device, in a manner so that the first concentration ratio becomes the predetermined target concentration ratio.

In accordance with such features, the hydrogen gas and the carbon monoxide gas can be supplied at the appropriate concentration ratio to the synthesizing device. As a result, hydrocarbon gas can be stably synthesized without waste. This in turn contributes to a significant reduction in the generation of waste.

(2) In the present invention, the electrosynthesis system according to the aforementioned item (1) may further include the second analyzer (92) that measures the second concentration ratio, which is the concentration ratio between the carbon dioxide gas and the water vapor in the mixed gas supplied to the electrolysis device and containing the carbon dioxide gas and the water vapor, and the control device may adjust the flow rate of the water vapor, in a manner so that the second concentration ratio becomes the target concentration ratio until the electrical current supplied to the electrolysis device reaches the predetermined electrical current value. In accordance with such features, even if the electrolytic reaction of the electrolysis device is unstable, the gas composition ratio on the downstream side of the electrolysis device can be brought closer to the target concentration ratio.

(3) In the present invention, the electrosynthesis system according to the aforementioned item (1) may further include the water vapor generator (12) that evaporate the water, the heater (16) that heats the water vapor generated by the water vapor generator, the primary water supply device (81) that supplies the water to the water vapor generator, and the secondary water supply device (82) that supplies the water to the water vapor passage (33) that places the water vapor generator and the heater in communication, wherein the control device may control the first supply amount of the water supplied from the primary water supply device to the water vapor generator and the second supply amount of the water supplied from the secondary water supply device to the water vapor passage, and may thereby adjust the flow rate of the water vapor supplied from the heater to the electrolysis device. In accordance with such features, the supply of the water vapor to the electrolysis device can be made more stable in comparison with a case in which the supply system is only one system.

(4) In the present invention, the electrosynthesis system according to the aforementioned item (3) may further include at least one of the first dehumidifier (71) that extracts the moisture within the mixed gas, or the second dehumidifier (72) that extracts the moisture within the hydrocarbon-containing gas discharged from the synthesizing device and containing the hydrocarbon gas, wherein the secondary water supply device may supply the water extracted by the first dehumidifier or the second dehumidifier. In accordance with such features, the water utilization efficiency can be increased.

(5) In the present invention, the electrosynthesis system according to the aforementioned item (4) may further include the temperature sensor (93) that detects the outside air temperature, and the control device may switch between controlling the first supply amount and controlling the second supply amount in accordance with the outside air temperature. In accordance with such features, a situation can be prevented in which supplying of the water vapor to the electrolysis device becomes impossible due to freezing of the water at a time of low temperature.

(6) In the present invention, in the electrosynthesis system according to the aforementioned item (5), in the case that the outside air temperature is less than or equal to the predetermined temperature threshold value, the control device may control the second supply amount with priority over the first supply amount. In accordance with this feature, even if the outside air temperature is low, the water recovered by the first dehumidifier or the second dehumidifier can be supplied to the electrolysis device in the form of water vapor via the heater. As a result, even if the water supplied to the water vapor generator freezes, the water vapor is capable of being supplied to the electrolysis device.

The present invention is not limited to the embodiment and the modifications thereof described above. Various modifications can be adopted therein within a range that does not depart from the essence and gist of the present invention, or alternatively, within a range that does not depart from the essence and gist of the present invention as derived from the content stated in the claims and equivalents thereof.

1. An electrosynthesis system comprising an electrolysis device configured to perform electrolysis on carbon dioxide gas and water vapor, and a synthesizing device configured to synthesize hydrocarbon gas from hydrogen gas and carbon monoxide gas that are generated by the electrolysis, the electrosynthesis system further comprising:
a first analyzer configured to measure a first concentration ratio, which is a concentration ratio between the hydrogen gas and the carbon monoxide gas in a mixed gas discharged from the electrolysis device and containing the hydrogen gas and the carbon monoxide gas; and
a control device configured to adjust a flow rate of the water vapor supplied to the electrolysis device, in a manner so that the first concentration ratio becomes a predetermined target concentration ratio.

2. The electrosynthesis system according to claim 1, further comprising:
a second analyzer configured to measure a second concentration ratio, which is a concentration ratio between the carbon dioxide gas and the water vapor in a mixed gas supplied to the electrolysis device and containing the carbon dioxide gas and the water vapor,
wherein the control device adjusts the flow rate of the water vapor, in a manner so that the second concentration ratio becomes the target concentration ratio until an electrical current supplied to the electrolysis device reaches a predetermined electrical current value.

3. The electrosynthesis system according to claim 1, further comprising:
a water vapor generator configured to evaporate water;
a heater configured to heat the water vapor generated by the water vapor generator;
a primary water supply device configured to supply the water to the water vapor generator; and
a secondary water supply device configured to supply the water to a water vapor passage configured to place the water vapor generator and the heater in communication,
wherein the control device controls a first supply amount of the water supplied from the primary water supply device to the water vapor generator and a second supply amount of the water supplied from the secondary water supply device to the water vapor passage, and thereby adjusts a flow rate of the water vapor supplied from the heater to the electrolysis device.

4. The electrosynthesis system according to claim 3, further comprising at least one of:
a first dehumidifier configured to extract moisture within the mixed gas; or
a second dehumidifier configured to extract moisture within a hydrocarbon-containing gas discharged from the synthesizing device and containing the hydrocarbon gas,
wherein the secondary water supply device supplies the water extracted by the first dehumidifier or the second dehumidifier.

5. The electrosynthesis system according to claim 4, further comprising:
a temperature sensor configured to detect an outside air temperature,
wherein the control device switches between controlling the first supply amount and controlling the second supply amount in accordance with the outside air temperature.

6. The electrosynthesis system according to claim 5,
wherein in a case that the outside air temperature is less than or equal to a predetermined temperature threshold value, the control device controls the second supply amount with priority over the first supply amount.
